(19) United States
(12) Patent Application Publication
(10) Pub. No.: US 2009/0185969 A1
(43) Pub. Date: Jul. 23, 2009

(54) HELIUM RECOVERY FROM SEMICONDUCTOR CLUSTER TOOLS

(76) Inventors: Niels LOSE, Starnberg (DK); William Robert GERRISTEAD, High Bridge, NJ (US); Keonhwan CHO, Seoul (KR)

Correspondence Address: The BOC Group, Inc., 575 MOUNTAIN AVENUE, MURRAY HILL, NJ, 07974-2082, US

(21) Appl. No.: 12/334,890

(22) Filed: Dec. 15, 2008

(30) Foreign Application Priority Data
Jan. 22, 2008 (KR) 10-2008-0006470

(51) Int. Cl. C01B 23/00; B01D 53/00

(52) U.S. Cl. 423/262; 96/399

(57) ABSTRACT

Systems for the recovery of rare gas from a mixed gas stream are described. In particular, systems for the recovery of helium from cluster tools used in semiconductor fabrication are described. In one embodiment, these systems allow for the recovery of rare gas, such as helium, from the waste gas from a processing chamber, or a cluster tool, when a predetermined amount of rare gas is known to be present in the waste gas. In a further embodiment, analyzing means are used to determine the amount of rare gas, such as helium, present in the waste gas and when that amount warrants, the rare gas is recovered from the waste gas using a dedicated rare gas recovery process.

### FIELD OF THE INVENTION

The present invention relates to systems for the separation and recovery of rare gas from a mixed gas stream. More particularly, the present invention relates to the recovery of helium from cluster tools used in the semiconductor industry.

### BACKGROUND OF THE INVENTION

The fabrication of semiconductor devices require a wide range of processing steps, including processes to treat semiconductor substrates to achieve desired substrate properties. These processes often require the use of rare gases. In order to meet high throughput demands of the semiconductor industry, cluster tools that comprise a plurality of substantially identical process modules have been employed. The processes carried out in these cluster tools also require the use of rare gases such as helium or gas mixtures containing helium.

Process chambers or cluster tools often have a load lock chamber associated therewith, the load lock chamber allowing for substrates to be transferred in and out of the single process chambers or the various process chambers making up the cluster tool. The load lock chamber also allows for the delivery and evacuation of process gases, including rare gases such as helium, to the process chambers. The load lock chamber is typically connected to a vacuum pump that provides the means to deliver and evacuate the gases from the process chambers. The outlet from the vacuum pump contains the evacuated gases, which may include significant quantities of helium or other rare gases. The evacuated gas stream is typically sent to a gas abatement system or directly vented to the atmosphere. In other words, there is no recovery of rare gases, including helium from the off gases.

Many rare gases are in relatively scarce supply and can be relatively expensive to use. For example, Helium is found in nature primarily along with natural gas. Helium can not be synthesized and therefore is in limited supply. Many of the semiconductor fabrication processes use large quantities of rare gases, primarily helium. Cluster tools that can be comprised of several to hundreds of process chambers each operating approximately 8000 hours per year, multiply the amount of rare gases, e.g. helium, used to extremely high amounts. Moreover, current shortages of rare gases, particularly helium make the cost of using such rare gases prohibitive without some form of recycle and reuse.

Therefore, there is a need in the art for systems to recover and reuse rare gases from mixed gas streams. There is a particular need in the art for systems to recover and reuse helium from semiconductor fabrication cluster tools.

### SUMMARY OF THE INVENTION

The present invention provides systems for the separation, recovery and reuse of rare gases from a mixed gas stream. In particular, the present invention provides systems for the recovery of rare gases such as helium from cluster tools used in semiconductor fabrication. The system of the present invention allows for the separation and recovery of rare gases, such as helium from a mixed gas stream, such as a waste gas stream from cluster tools, when a predetermined amount of the rare gas is known to be present in the mixed gas stream. A further embodiment of the present invention includes analyzing means used to determine the amount of rare gas, e.g. helium, present in the mixed gas stream and means to send the mixed gas stream to a dedicated rare gas recovery process rather than the general exhaust system when the amount of rare gas warrants recovery.

### BRIEF DESCRIPTION OF THE DRAWINGS

FIG. 1 a schematic view of a system for the separation and recovery of rare gas from a mixed gas stream according to an embodiment of the present invention.

FIG. 2 is a sequence flow diagram for a system to separate and recovery rare gas from a mixed gas steam in accordance with the present invention.

FIG. 3 is a schematic view of a system for the recovery of helium from the waste gas of a cluster tool according to a further embodiment of the present invention.

FIG. 4 is a schematic view of a system for the recovery of helium from the waste gas of a cluster tool according to another embodiment of the present invention.

### DETAILED DESCRIPTION OF PREFERRED EMBODIMENTS

The present invention provides systems for the recovery of rare gases from a mixed gas stream and particularly provides for the recovery of helium from cluster tools used in semiconductor fabrication. Several embodiments according to the present will be described with reference to the drawing figures.

The method of the present invention generally provides for the separation of rare gas from a mixed gas stream, such as the exhaust gas from a load lock chamber. At different stages of wafer or substrate processing, the concentration of rare gas in the mixed exhaust gas is very high and can be feasibly and economically separated, while at other stages of processing, there is little or no rare gas present in the mixed exhaust gas and separation or recovery of the rare gas would be unwarranted. The present invention provides a method for determining stages of processing when enough rare gas is present in the mixed exhaust gas to make separation desirable, and further provides an apparatus to carry out the separation and recovery during such stages.

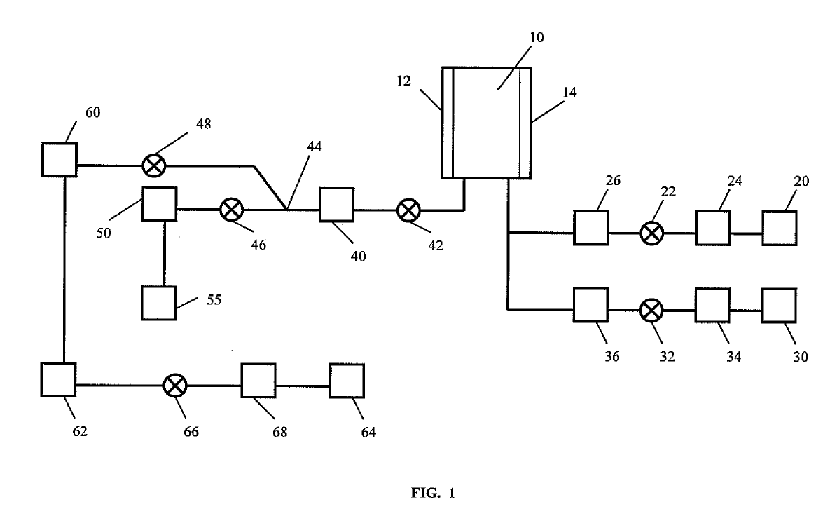

A first embodiment of the present invention is described with reference to FIG. 1, which is a schematic view of a system for the separation and recovery of rare gas from a mixed gas stream. In particular, FIG. 1 shows a system having a load lock chamber 10, with an inlet door 12, and an outlet door 14, that allows for wafers or substrates to be introduced and extracted from the chamber 10. The chamber 10, is connected to gas supply lines and to an exhaust line for supply of gas and evacuation of gas from the chamber 10, respectively. A first gas supply line for providing rare gas to cool wafers or substrates in the chamber 10, comprises a rare gas supply source 20, connected to the chamber 10, through rare gas control valve 22, and may optionally include a rare gas regulator 24, and a rare gas filter 26. A second gas supply line for providing purge gas to the chamber 10, comprises a purge gas supply source 30, connected to the chamber 10, through a purge gas control valve 32, and may optionally include a purge gas regulator 34, and a purge gas filter 36.

The exhaust line for evacuation of the chamber 10, includes a vacuum pump 40, connected to the chamber 10, through a exhaust gas control valve 42. Exhaust gas exiting the vacuum pump 40, can be directed through two separate paths in accordance with the present invention. In particular, as shown in FIG. 1, a Y branch 44, associated with a first exhaust gas separation valve 46, and a second exhaust gas separation valve 48, that can be manually or preferably automatically controlled in accordance with a predetermined sequence, allow for treatment of the exhaust gas in two separate processes depending on the amount of rare gas that is present in the exhaust gas at a given time during the processes conducted by the system. While the Y branch 44 and first and second valves 46 and 48, show one embodiment, other arrangements for accomplishing the same type of flow are contemplated, such as the use of a three way valve.

In operation, when first valve 46, is open and second valve 48 is closed, exhaust gas is sent through the standard abatement processes for the system, which may include standard abatement equipment 50, and an exhaust duct and blower 55. When the exhaust gas from the vacuum pump 40, does not contain enough rare gas to warrant recovery, then the exhaust gas is treated by the standard abatement process. However, when there is sufficient rare gas within the exhaust gas from the vacuum pump 40, to warrant separation and recovery, then first valve 46, is closed and second valve 48 is opened to allow the exhaust gas to flow through the rare gas separation and recovery lines. In particular, the exhaust gas passes through a manifold 60, and then to a buffer tank 62, prior to being sent to a compressor 64, via an inlet valve 66, and filter 68.

The vacuum pump 8, controls pressure within the system and controls the flow of gases into the chamber 10, as well as evacuation of the chamber 10. The valves 42, 46, 48, also serve to control the flow of gases, particularly through the standard exhaust path or through the rare gas recovery path separated at the Y branch 44. An automatic controller can be used to control the opening and closing of the valves 42, 44 and 46, in response to signals that indicate various process stages are being carried out. The controller can be an electronically controlled device wherein electric signals control the opening and closing of the valves 42, 44, 46, according to a predetermined sequence, depending on the amount of rare gas present in the mixed exhaust gas coming from the chamber 10. The controller is also connected with the chamber 10, and receives signals that indicate the opening and closing of the doors 12, 14, so that the flow of exhaust gas can be properly coordinated with the amount of rare gas in the exhaust gas at different stages of wafer processing. The controller is also connected to the valves 22, 32, to control the flow of the rare gas and purge gas into the chamber 10.

The preferred material for the conduits, pipes and valves of the system is stainless steel with KF or welded couplings. Preferred valves are those that minimize the pressure drop for the rare gas and the exhaust gas. The manifold and exhaust duct can be plastic, such as FRP, PE or metal.

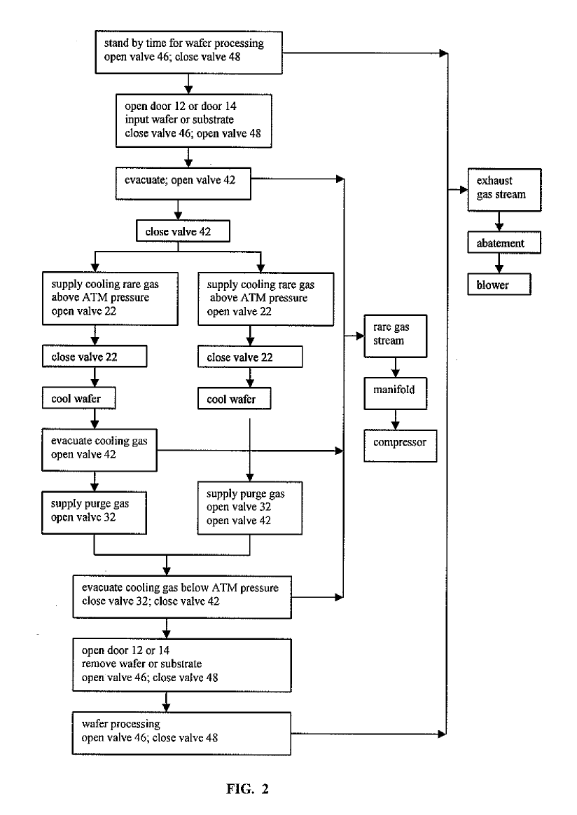

FIG. 2 is a sequence flow diagram for operation for the system of the present invention with reference to the components of FIG. 1. In particular, when the chamber 10, is in standby mode such as at start up or when no wafer is present in the chamber 10, then any exhaust gas is sent through the standard exhaust path, by opening valve 46, and closing valve 48, so that exhaust gas is directed through the abatement equipment 50, and blower 55. Door 12 or 14, is opened for insertion of a wafer or substrate and then the door 12 or 14, is closed. At this time valve 46, is closed and valve 48, is open so that when the next exhaust gas leaves the chamber 10, it will be directed through the rare gas recovery path. The chamber 10, is then evacuated using the vacuum pump 8, and opening valve 42. Any gas that is present in the chamber 10, at this time will be evacuated and pass through the rare gas recovery path, including the manifold 60, buffer tank, 62 and compressor 64. Upon reaching the desired chamber pressure, valve 42 is closed. Cooling rare gas is then supplied to the chamber 10, by opening valve 22, until sufficient rare gas has been introduced to the chamber 10, and then valve 22 is closed. In one alternative, when the wafer or substrate in the chamber 10, has been cooled, the rare gas is evacuated from the chamber 10, by the vacuum pump 8, upon opening of the valve 42. Because valve 46, remains closed and valve 48, remains open, the exhaust gas during this stage of high concentration of rare gas may be passed through the rare gas recovery path. Purge gas is then supplied to the chamber 10, by opening valve 22. In a second alternative, after the wafer has been cooled, purge gas is supplied to the chamber 10, by opening valve 32, without first evacuating the chamber 10. Rather, in this alternative, evacuation occurs after the flow of purge gas begins, by opening valve 42. The purge gas serves to purge the cooling rare gas from the chamber 10, and the exhaust gas, high in rare gas concentration proceeds through the rare gas recovery path. The purge gas flow is stopped after a predetermined time by closing valve 32, and then valve 42, is closed to end exhaust gas flow. With the wafer or substrate process complete, the door 12 or 14, is opened and the wafer or substrate is removed. At this time, valve 46, is opened and valve 48, is closed so that exhaust gas which is very low in rare gas concentration is directed through the standard exhaust path. A new wafer can then be introduced to the chamber 10, and the cycle repeated.

Desired pressures for the system can be maintained by controlling the flow of rare gas and purge gas as well is evacuation using the vacuum pump 8, through manipulation of the valves 22, 32, and 42, and through the timed sequence of the opening and closing of doors 12, 14, of chamber 10. The result of this method is that only the exhaust gas exiting the chamber 10, during wafer cooling and purge stages, when rare gas concentration is high, is sent through the rare gas recovery path, while exhaust gas exiting the chamber 10, during wafer processing stages, flows through the standard exhaust path and is abated by standard means. In one specific example, when a signal is received by the controller indicating that a wafer or substrate has been introduced to the chamber 10, the valve 48, is opened and two seconds later valve 46, is closed. When a signal is received by the controller indicating that a wafer or substrate has been removed from the chamber 10, the valve 46, is opened and two seconds later valve 48, is closed.

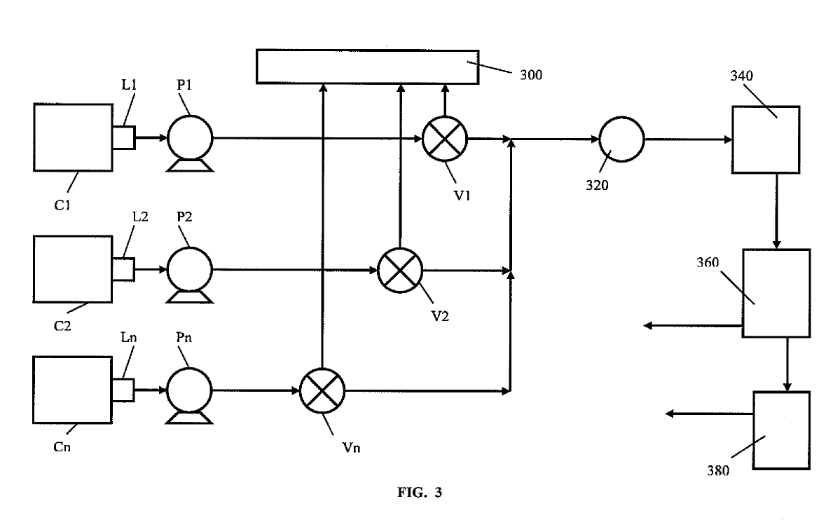

A further embodiment of the present invention will be described with reference to FIG. 3. As shown in FIG. 3, cluster tools C1, C2, Cn, each have a load lock L1, L2, Ln, and vacuum pump P1, P2, Pn, associated therewith to evacuate process gases from the tools C1-n, after process steps are completed. As noted above, many of the processes used in the fabrication of semiconductors require helium, or mixed gases containing helium, resulting in large quantities of helium being present in the waste gas evacuated from the tools C1, C2, Cn. The system of FIG. 1 is particularly useful for situations where it is known that an average amount of helium is present in the waste gas, at least following certain process steps. When the waste gas from particular process steps does not contain helium or contains helium in amounts too low to be recovered economically, the waste gas passes from the vacuum pumps P1, P2, Pn, through a valve system, V1, V2, Vn, such as three way valves, to the general exhaust system 300, for the facility. However, when the waste gas contains helium in amounts that warrant recover and reuse, the waste gas passes from the vacuum pumps P1, P2, Pn, through the valve systems V1, V2, Vn, to a dedicated helium recovery system. The valve systems V1, V2, Vn, can be controlled using logic provided by the cluster tools C1, C2, Cn.

The dedicated helium recovery system shown in FIG. 3, includes a compressor/blower unit 320, where the waste gas is compressed and then sent to a buffer tank 340, that both stores and mixes the compressed waste gas. From the buffer tank 340, the waste gas is sent to a purification unit 360, that separates the helium from the rest of the waste gas and purifies the separated helium. Any conventional method and apparatus for separating and purifying the helium in the waste gas can be utilized as the purification unit 360. Operating conditions will be dependent on the conditions of the waste gas, e.g. concentration, flow rates, temperatures, impurities, etc., as well as the desired purity level of the recovered helium.

Helium recovered from the purification unit 360, is particle free gaseous helium ranging in purity from industrial quality to high purity grades. The recovered helium can be provided from the purification unit 360, directly back to the process steps or can be collected and sold commercially. When reusing in the fabrication facility, the recovered helium can be mixed with fresh helium to obtain sufficient quantities required for a particular process step.

Alternatively, some or all of the helium exiting the purification unit 360, can be sent to a helium liquefier 380, for liquefaction. The liquefied helium can also be reused by the fabrication facility or sold commercially.

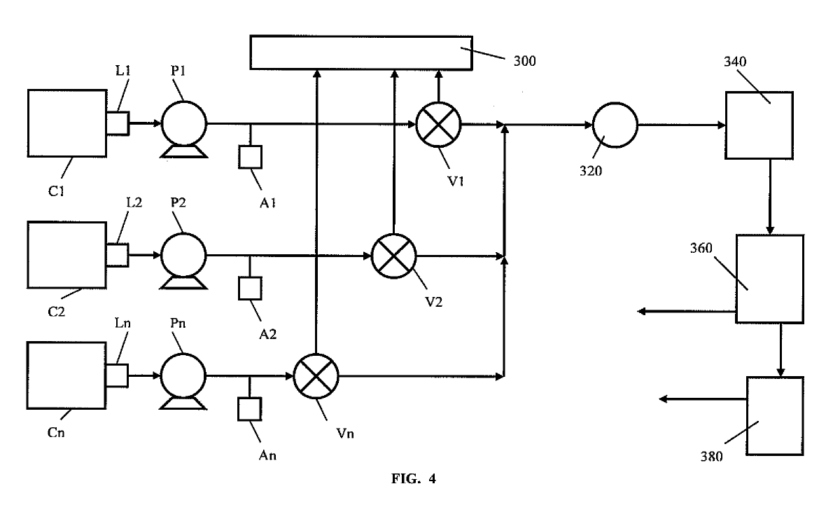

Another embodiment of the present invention will be described with reference to FIG. 4, wherein like elements are shown with like reference identifiers used in FIG. 3. In particular, the system of FIG. 4, is identical to the system of FIG. 3, but includes the addition of analyzers A1, A2, An, associated with the waste gas stream coming from each vacuum pump P1, P2, Pn. The analyzers A1, A2, An, are needed in situations where the composition of the waste gas is not known in advance or where it is desired to have a separate analysis done on the waste gas to determine if the recovery of helium from the waste gas is warranted. In this embodiment the control of the valve systems V1, V2, Vn, is governed by the results of the analysis carried out by the analyzers A1, A1, An. Therefore, when the analyzers A1, A2, An, determine that the amount of helium in the waste gas is not at a level high enough to warrant recovery, the valve systems, V1, V2, Vn, direct the waste gas to the general exhaust system 300, for the facility. Conversely, when the analyzers A1, A2, An, determine that the waste gas contains helium in amounts that warrant recover and reuse, then the waste gas passes from the vacuum pumps P1, P2, Pn, through the valve systems V1, V2, Vn, to the dedicated helium recovery system.

The dedicated helium recovery system of FIG. 4, can be same as that shown in FIG. 3, again including a compressor/blower unit 320, a buffer tank 340, a purification unit 360, and optionally a helium liquefier 380. As noted, any conventional method and apparatus for separating and purifying the helium in the waste gas can be utilized and operating conditions will be dependent on the conditions of the waste gas, e.g. concentration, flow rates, temperatures, impurities, etc., as well as the desired purity level of the recovered helium. Helium recovered from the purification unit 360, or from the helium liquefier 380, can be reused by the fabrication facility or can be sold commercially.

In accordance with another embodiment of the present invention, the application of the systems and methods described above could be significantly complex when applied to cluster tools having a large number of chambers. In particular, the ability to meet the switching requirements between rare gas recovery and standard exhaust treatment based on input from a large number of chamber operations could prove to difficult to control effectively. Therefore, the present invention also includes a process wherein all exhaust gas is passed through the rare gas recovery lines. In general, with a large number of chambers in a cluster, there should be enough rare gas at any given time to warrant separation and recovery, therefore making this embodiment feasible and economically viable.

The present invention provides several advantages. In particular, by utilizing the system of the present invention, a significant amount of helium can be recovered and reused, thus significantly reducing the amount of fresh helium needed to carry out processes and thereby reducing process costs. Alternatively, the recovered helium can be sold commercially, providing an income stream and thereby reducing overall costs.

While the invention has been described with specific reference to semiconductor fabrication, the systems of the present invention could be used for other processes, including LCD, flat panel production, solar cell production, glass coating processes, etc. In fact any process that requires the use of large quantities of helium which is not consumed in the process can benefit from using the systems of the present invention.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

What is claimed is:

1. A method of recovering a rare gas from a mixed gas stream comprising
determining the amount of rare gas in the mixed gas stream at different times during a cyclical process;
exhausting the mixed gas stream through a waste gas abatement process when the determined amount of rare gas in the mixed gas stream is below a predetermined level;
treating the mixed gas stream in a rare gas separation and recovery process when the determined amount of rare gas in the mixed gas stream is above the predetermined level.

2. A method according to claim 1, wherein the mixed gas stream is the waste gas from at least one cluster tool.

3. A method according to claim 1, wherein the rare gas is helium.

4. A method according to claim 1, wherein the predetermined level is such that all of the mixed gas stream is treated in the rare as separation and recovery process.

5. An apparatus for separating a rare gas from a mixed gas stream comprising:
at least one load lock chamber having an inlet door and an outlet door for introduction and removal of a substrate to be treated and a waste gas exhaust;
a rare gas supply source in communication with the load lock chamber;
a purge gas supply source in communication with the load lock chamber;
a waste gas treatment system in communication with the waste gas exhaust, comprising
a waste gas abatement system;
a rare gas recovery system; and
switch means to send the mixed gas stream exiting the load lock chamber to either the waste gas abatement system or the rare gas recovery system based on the amount of rare gas present in the mixed gas stream at any given time during a process carried out on the substrate.

6. An apparatus according to claim 5, wherein the switch means comprises a Y branch and two valves.

7. An apparatus according to claims 5, wherein the switch means comprises a three way valve.

8. An apparatus according to claim 5, wherein the rare gas is helium.

9. A method of recovering rare gas from a mixed exhaust gas from a semiconductor processing chamber, comprising:
inserting a substrate into the processing chamber;
evacuating the processing chamber;
treating the substrate according to a desired semiconductor device attribute;
introducing cooling rare gas to the chamber to cool the substrate;
exhausting mixed exhaust gas from the chamber through a rare gas recycling system;
introducing purge gas to the chamber;
exhausting further mixed exhaust gas from the chamber through a waste gas abatement system; and
removing the substrate from the chamber.

10. A method according to claim 9, wherein the rare gas is helium.

11. A method according to claim 9, wherein the substrate is a wafer.
